(19) United States
(12) Patent Application Publication
(10) Pub. No.: US 2006/0122898 A1
(43) Pub. Date: Jun. 8, 2006

(54) Method and device for billing charges in a communication network with point-to-point connections

(75) Inventors: Frank-Uwe Andersen, Berlin (DE); Uwe Foll, Falkensee (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munich (DE)

(21) Appl. No.: 11/216,461

(22) Filed: Sep. 1, 2005

(30) Foreign Application Priority Data
Sep. 2, 2004 (DE) 10 2004 042 559.0

(51) Int. Cl. G06Q 30/00

(52) U.S. Cl. 705/26; 705/5

(57) ABSTRACT

A method for billing charges in a communications network with point-to-point connections. The method includes transmitting a message from a service-receiving end point to a service-switching network node which buffers the message, transmitting service-related data from a service providing end point directly to the service receiving end point, transmitting a message from the service-providing end point) to the service-switching network node, comparing the received messages by the service-switching network node and transmitting a charge credit to the service-providing end point depending on the result of the comparison. The invention also includes a device for executing the above method.

### CLAIM FOR PRIORITY

This application claims the benefit of priority to German Application No. 10 2004 042 559.0 which was filed in the German language on Sep. 2, 2004 the contents of which are hereby incorporated by reference.

### TECHNICAL FIELD OF THE INVENTION

The invention relates to a method and a device for billing charges in a communication network with point-to-point connections (peer-to-peer=P2P”), as well as point-to-server connections and additional Infrastructure (hybrid P2P network).

### BACKGROUND OF THE INVENTION

Information, e.g. films, music or other digital content is exchanged over the Internet by means of the existing point-to point communication networks. The method is based on a voluntary and free supply and on any level of demand.

A balance of the existing asymmetries between supply and demand (there are a small number of subscribers with a large supply of files and an unequally higher number of subscribers who themselves offer little or nothing) is not provided by the volume-based billing of charges. With such payment methods, which are used in particular for mobile data services, the one subscriber pays for all data packets sent and also for those received.

This means that no check is made on whether a subscriber of a P2P (peer-to-peer) network is downloading more than they are uploading. Such methods are not necessary in the fixed network Internet for the reason that the transmission costs are not of such great significance as in mobile radio. In addition the subscribers in ISDN for example are provided with separate up-link and downlink channels, in which case it may not matter to the provider whether additional data will be transmitted on the uplink channel.

If P2P networks are applied in cases of mobile radio Internet the asymmetries in supply and demand are of much greater consequence. In particular high costs on one side can lead to mobile subscribers not accepting mobile services. For example a mobile subscriber offering a self-created ring tone for downloading via a P2P network has to contribute to the not inconsiderable transmission charges of each transmission to an interested party for this ring tone (at the same or a similar tariff as those who are downloading the ring tone from him), since these costs are independent of the direction of the transmission.

Thus today's billing does not correspond to the roles played by the subscribers in this transaction, namely that of “supplier” and “consumer” (a “peer” can assume both roles).

The scope for resolving this problem extends from making an allowance for costs to the mobile content provider and doubling the charges for those downloading data from him (the sum remains the same in this case for the mobile network operator), through an additional expenses reimbursement (resources such as the physical device of the provider of also used) for the mobile content provider and also the operator for the specific form of billing through to models which additionally allow profits to be made.

Furthermore there exist in the Internet as well as in the socalled mail box scene approaches which do not allow too unequal a ratio of file upload and download transactions to arise (see below). These operate centrally and register the upload transaction centrally and are thus not usable in cellular mobile radio in the sense of P2P, specifically where two mobile subscribers are exchanging data or content directly, i.e. without intermediate servers.

The asymmetries discussed above are currently only compensated for by the fact that overload prevention mechanisms exist in the applications for example. Methods are also used which check whether the user requesting content has sufficient content available themselves to offer (e.g. 1 Mbyte, stored in a directory enabled for downloading). A variant of this is the quota method in which a subscriber requesting content works through a history of upload transactions which later allow downloading in a specific ratio (typically 1:5) in relation to the provider or providers.

### SUMMARY OF THE INVENTION

The overcomes disadvantages for billing in P2P communications networks.

In one embodiment of the invention, there is a method for billing charges in a communications network with point-to-point connections comprising:

Transmission of a message from an end point receiving a service to a network node switching a service, which buffers the message,

Transmission of service-linked data from an end point offering a service direct to the end point receiving the service

Transmission of a message from the end point offering the service to the network node switching the service,

Comparison of the received messages by the service-switching network node, and

Transmission of a charge credit to the end point offering the service depending on the result of the comparison.

In another embodiment of the invention, there is a device for executing the above-mentioned method, including:

a first unit for receiving a message, transferred from an end point receiving the service, which is buffered,

a second unit for receiving a message sent from a service-providing end point,

a third unit for comparing the received messages and

a fourth unit for transmitting a charge credit to the service providing end point depending on the result of the comparison.

Advantages of the invention are:

The subscribers would use the P2P services of the mobile operator and not those in the Internet since they would receive a bonus for the former (e.g. reimbursement of the transmission charges). Specifically those who only retrieve data instead of making any available themselves would otherwise pay more in this case.

The mobile radio operators could offer a large volume of additional content via P2P networks without additional costs.

The operators do not need to provide any content themselves since the subscribers generate and offer the very latest information themselves (“user-created mobile content”), such as self-generated ring tones, images, films, text files etc.

It would make acceptance of P2P networks possible for the first time since otherwise subscribers would not be able to calculate their costs. If popular content were to be offered, the provider could obtain five-digit charge revenue from the other subscriber downloads within a very short time.

Special tariffs could be offered for P2P services which already included in the transmission charges of the provider

### BRIEF DESCRIPTION OF THE DRAWINGS

The invention is described below in more detail with reference to exemplary embodiments and the drawings, in which:

FIG. 1 shows a typical configuration of a mobile communication network.

### DETAILED DESCRIPTION OF THE INVENTION

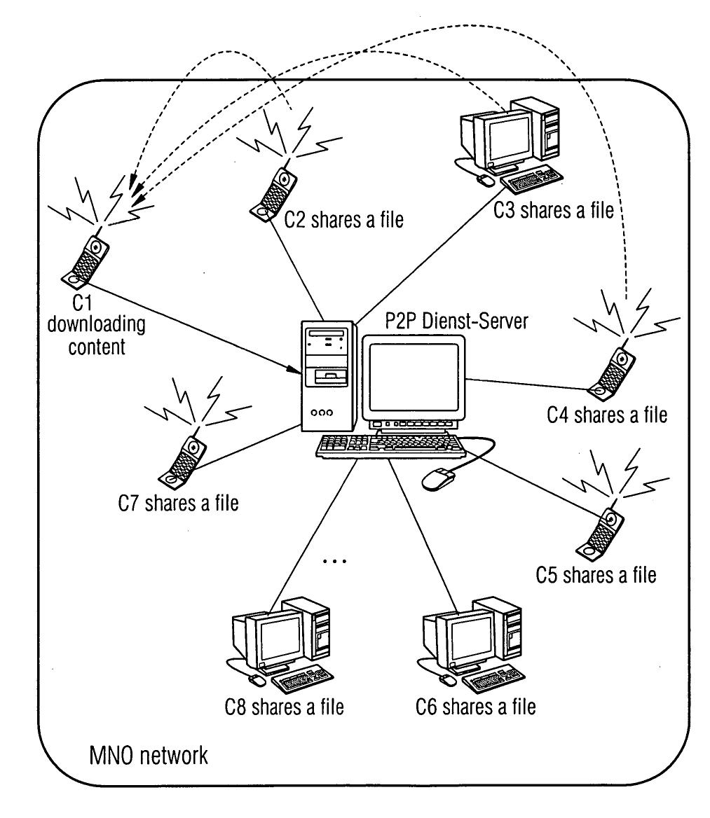

FIG. 1 shows end points in the form of mobile terminals C1 to C8 which feature a connection to a service-switching network node P2P service server. Furthermore, the end points can be connected directly to each other as is indicated, for example, in the figure by the dashed lines.

To compensate for an imbalance between supply and demand, the consumers accept all or part of the transmission charges of the provider. This is referred to below as “reverse charging” and approximately corresponds to the reverse-charge call known from telephony. To this end for each subscriber, the volume which he has requested over a P2P network is recorded, debited to the downloader and credited to those subscribers who have provided the information. This type of recording is possible in particular with hybrid P2P networks, since with such networks the P2P traffic is controlled through a central server.

With a hybrid P2P network communication is implemented by a centralized search function on a server, i.e. a service-switching server. This server can return on the basis of a file name a list of end points which keep this file or parts of it available. The service can now assume that the download peers or end points (C1-C8) suggested to the requesting end point can also be addressed, at least some of them. The service cannot exercise any control over the direct download transactions, that is point-to-point connections and can also not determine these directly.

The solution lies in the downloading being verified indirectly via the server service. In this case the end points exchange the useful data directly, the control signaling involved in the exchange however is undertaken via the server service. To verify the transmission of data from the end point offering the service to the end point receiving the service, the requesting end point sends an appropriate message to the server service. The message is briefly stored here. Subsequently the requesting end point begins the download from the providing end point. This will first check whether there is a “registered” request for the file which it is offering (by interrogating the server service=authentication)). If there is, the service-related transmission is executed. After the data has been transmitted the providing end point will signal the data transmission to the server service in order to receive a credit. The server service will check this by comparing this message with the original message from the requesting end point (download request). If the result is positive the server service generates a credit ticket which is sent to the billing service (not charging). At this last station an additional check is made as to whether the “assumed” volumes of data have actually occurred at the receiving and the providing end point. To this end the data records of the access network are evaluated. In another variant the server service can access the data of the access network directly and generate a credit ticket which does not have to be checked by the billing process.

If the result is positive the sum which was billed for the transmission of the relevant file is deducted. This sum can be billed to the requesting end point. Additional information about the transmission can be made available by the network element of the access network, e.g. GPRS. The P2P server could for example have the transmission volumes of the network nodes such as GGSN or SSG notified to it and then aggregate these.

1. A method for billing charges in a communication network with point-to-point data connections, comprising:
transmitting a message from a service receiving end point to a service-switching network node service server which buffers the message;
transmitting service-related data from a service providing end point directly to a service receiving end point;
transmitting another message from the service-providing end point to the service switching network node;
comparing the received messages by the service-switching network node; and
transmitting a charge credit to the service providing end point depending on a result of the comparison.

2. The method in accordance with claim 1, wherein the service-providing end point checks the authenticity of the service-receiving end point.

3. The method in accordance with claim 1, wherein the charge credit is handled via a billing service or an online charging service.

4. The method in accordance with claim 1, wherein the data records in the communication netowrk are checked for the charge credit.

5. A service-switching network node for, billing charges in a communication network with point-to-point data connections comprising:
first unit for receiving a message transmitted by a service-receiving end point which is buffered;
a second unit for receiving a message transmitted by a service-providing end point;
a third unit for comparing the received messages; and
a fourth unit for transmitting a charge credit to the service-providing end point depending on a result of the comparison.
